(19) United States
(12) Patent Application Publication
(10) Pub. No.: US 2009/0308266 A1
(43) Pub. Date: Dec. 17, 2009

(54) APPARATUS FOR STORING AND DISPENSING SPREADABLE FOOD ITEM

(76) Inventor: Timothy Zalesky, Patterson, NY (US)

Correspondence Address: JAY M. SCHLOFF, 6960 Orchard Lake Road, Suite 315, West Bloomfield, MI, 48322, US

(21) Appl. No.: 12/485,403

(22) Filed: Jun. 16, 2009

Related U.S. Application Data
(60) Provisional application No. 61/132,226, filed on Jun. 17, 2008.

(51) Int. Cl. A47J 43/04; B67D 5/40; B67D 5/63

(52) U.S. Cl. 99/537; 222/386; 222/146.5

(57) ABSTRACT

An apparatus for storing and dispensing a spreadable food item onto a substrate. The apparatus includes an elongated member, a powering cabinet, and a plunger mechanism. The elongated member includes a grated base portion, and a projecting portion. The projecting portion extends vertically from the grated base portion for configuring a cavity portion. The cavity portion is capable of storing the spreadable food item. Further, the powering cabinet is detachably coupled to the elongated member for supplying power to heat the grated base portion. Furthermore, the plunger mechanism is operatively coupled to the elongated member. The plunger mechanism is capable of being actuated to push the spreadable food item stored within the cavity portion towards the grated base portion for dispensing the spreadable food item through the grated base portion heated by the powering cabinet onto the substrate.

### CROSS-REFERENCE TO RELATED APPLICATIONS

The present disclosure claims priority under 35 United States Code, Section 119 on the U.S. Provisional Patent Application No. 61/132,226 filed on Jun. 17, 2008, the disclosure of which is incorporated by reference.

### FIELD OF THE DISCLOSURE

The present disclosure relates, in general, to kitchen implements, and more particularly to an apparatus for storing and dispensing spreadable food items onto a substrate.

### BACKGROUND OF THE DISCLOSURE

Spreadable food items may include butter, cream, cheese, jam, cake frosting, and any other spreadable or formable products. However, herein butter will be used as an exemplary spreadable food item. Many individuals like the taste of butter, and the taste of a food product to which butter is applied. Typically, butter is stored in a refrigerator prior to use. The butter stored in the refrigerator is generally cold, and applying cold butter onto the food product is a tedious task. For example, to apply the cold butter onto a food product, the cold butter first needs to be retrieved from the refrigerator. Further, a desired portion of the cold butter needs to be sliced off using a knife. Furthermore, the desired portion of the cold butter is then placed onto the food product and spread over the food product.

Performing such a task each time for consuming a buttered food product may be frustrating to individuals. Specifically, the task of slicing the desired portion from the cold butter using the knife may be difficult, as the cold butter tends to slip off of a cutting implement or tray while being sliced. In such process, the individuals may slice off and end up using more butter than they actually desire or require. Further, spreading the desired portion of the cold butter onto the food product is often a difficult task to perform on soft food products, such as bread, as the cold butter is relatively solid. An alternate step to overcome such problem is to wait for the cold butter to come to room temperature to enable the spreading of the desired portion of the formerly-cold butter onto the food product in a convenient manner. Such waiting may be a time consuming and annoying step for the individuals. To overcome such problems, some individuals store the butter at room temperature, which may spoil and/or degrade the taste of the butter.

Accordingly, there exists a need to preclude frustrating and time consuming tasks for using butter on food products without spoiling and degrading the taste of the butter.

### SUMMARY OF THE DISCLOSURE

In view of the foregoing disadvantages inherent in the prior art, the general purpose of the present disclosure is to provide an apparatus for storing and dispensing a spreadable food item onto a substrate such as a food product, to include all advantages of the prior art, and to overcome the drawbacks inherent in the prior art.

An object of the present disclosure is to preclude frustrating and time consuming tasks for using a spreadable food item onto a substrate such as a food product without spoiling and degrading the taste the spreadable food item.

In light of the above object, in an aspect of the present disclosure an apparatus for storing and dispensing a spreadable food item onto a substrate is provided. The apparatus includes an elongated member, a powering cabinet, and a plunger mechanism. The elongated member includes a grated base portion, and a projecting portion. The projecting portion extends vertically from the grated base portion for configuring a cavity portion. The cavity portion is capable of storing the spreadable food item. Further, the powering cabinet is detachably coupled to the elongated member for supplying power to heat the grated base portion. Furthermore, the plunger mechanism is operatively coupled to the elongated member. The plunger mechanism is capable of being actuated to push the spreadable food item stored within the cavity portion towards the grated base portion for dispensing the spreadable food item through the grated base portion heated by the powering cabinet onto the substrate.

The apparatus as disclosed above is capable of precluding frustrating and time consuming tasks for using the spreadable food item, such as butter, cream, cheese, jam, cake frosting, and any other spreadable or formable products, onto the substrate, such as a food product, a cooking pan, a frying pan, and the like without spoiling and degrading the taste the spreadable food item. Particularly, the apparatus enables storage of the spreadable food item in the cavity portion of the elongated member. Further, the apparatus having the spreadable food item stored in the cavity portion of the elongated member may be stored in a refrigerator. When required, the apparatus may be retrieved from the refrigerator for spreading a desired amount of the spreadable food item onto the substrate. Specifically, the powering cabinet is capable of supplying power to heat the grated base portion, and the plunger mechanism is capable of being actuated for dispensing the desired amount of the spreadable food item onto the substrate through the grated base portion heated by the powering cabinet. The grated base portion when heated by the power supplied from the powering cabinet, also heats the spreadable food item, which is dispensed through the grated base portion by the plunger mechanism. The apparatus precludes various tasks, such as slicing the spreadable food item using a knife, waiting for the spreadable food item to come to the room temperature, and the like, thereby facilitating individuals to apply the desired amount of the spreadable food item in a time effective manner and without frustration.

This together with the other aspects of the present disclosure, along with the various features of novelty that characterized the present disclosure, is pointed out with particularity in the claims annexed hereto and forms a part of the present disclosure. For a better understanding of the present disclosure, its operating advantages, and the specified object attained by its uses, reference should be made to the accompanying drawings and descriptive matter in which there are illustrated exemplary embodiments of the present disclosure.

### BRIEF DESCRIPTION OF THE DRAWINGS

The advantages and features of the present disclosure will become better understood with reference to the following detailed description and claims taken in conjunction with the accompanying drawings, wherein like elements are identified with like symbols, and in which:

FIG. 1 illustrates a perspective view of an apparatus for storing and dispensing a spreadable food item onto a substrate, in accordance with an exemplary embodiment of the present disclosure;

FIGS. 2A through 2C illustrate various components of the apparatus, in accordance with an exemplary embodiment of the present disclosure;

FIG. 3A illustrates a sectional view of the apparatus along XX′ as shown in FIG. 1, in accordance with an exemplary embodiment of the present disclosure; and

FIG. 3B illustrates an enlarged view of an encircled portion of the apparatus of FIG. 3A, in accordance with an exemplary embodiment of the present disclosure.

Like reference numerals refer to like parts throughout the description of several views of the drawings.

### DETAILED DESCRIPTION OF THE DISCLOSURE

For a thorough understanding of the present disclosure, reference is to be made to the following detailed description, including the appended claims, in connection with the above-described drawings. Although the present disclosure is described in connection with exemplary embodiments, the present disclosure is not intended to be limited to the specific forms set forth herein. It is understood that various omissions and substitutions of equivalents are contemplated as circumstances may suggest or render expedient, but these are intended to cover the application or implementation without departing from the spirit or scope of the claims of the present disclosure. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

The term “first,” “second,” “top,” “bottom,” and the like, herein do not denote any order, elevation or importance, but rather are used to distinguish placement of one element over another. Further, the terms “a” and “an” herein do not denote a limitation of quantity, but rather denote the presence of at least one of the referenced item.

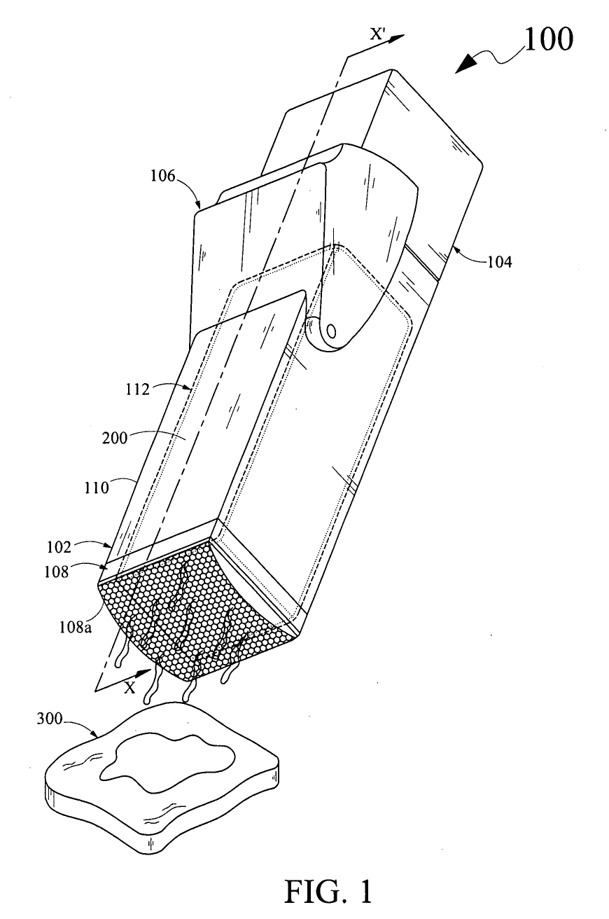

Referring now to FIG. 1, a perspective view of an apparatus 100 for storing and dispensing a spreadable food item onto a substrate is illustrated, in accordance with an embodiment of the present disclosure. The spreadable food item may include butter, cream, cheese, jam, cake frosting, and any other spreadable or formable products. Without departing from the scope of the present disclosure, herein after, butter will be used as an exemplary spreadable food item, and will be referred to as ‘butter 200’ (shown in FIG. 1). Further, the substrate may include a variety of food items, such as bread, and the like. The substrate may also include a frying pan, a cooking pan, and the like onto which the butter 200 may be dispensed for cooking purposes. Without departing from the scope of the present disclosure, herein after, bread will be used as an exemplary substrate, and will be referred to as ‘bread 300’ (shown in FIG. 1).

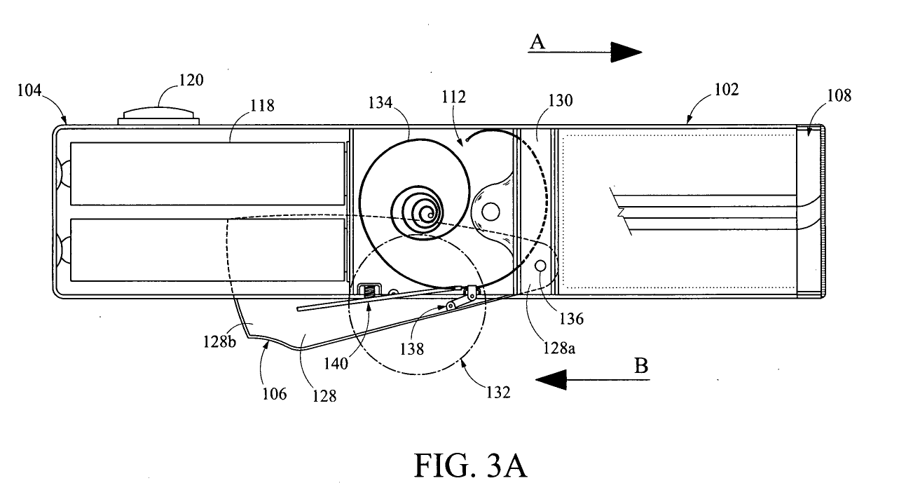

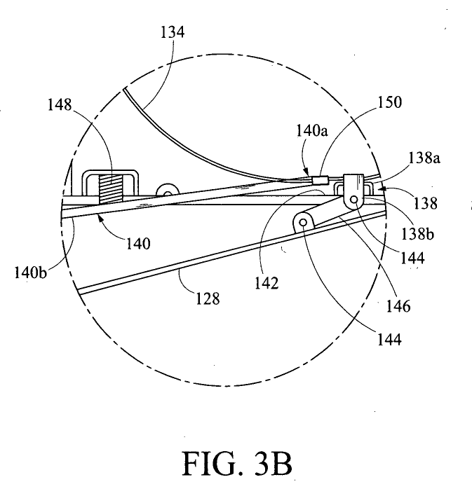

The apparatus 100 includes an elongated member 102, a powering cabinet 104 and a plunger mechanism 106. The powering cabinet 104 is detachably coupled to the elongated member 102. Further, the plunger mechanism 106 is operatively coupled to the elongated member 102. The elongated member 102 includes a grated base portion 108 and a projecting portion 110. The grated base portion 108 includes a plurality of openings 108a. The projecting portion 110 extends vertically from the grated base portion 108 for configuring a cavity portion 112. The cavity portion 112 is capable of storing the butter 200. The powering cabinet 104 is capable of supplying power to heat the grated base portion 108. Furthermore, the plunger mechanism 106 is capable of being actuated for pushing the butter 200 stored within the cavity portion 112. More particularly, the plunger mechanism 106 is capable of pushing the butter 200 towards the grated base portion 108. When the butter 200 touches the grated base portion 108, the butter 200 melts due to the grated base portion 108 being heated by the power supplied from the powering cabinet 104. Thereafter, the melted butter 200 may be dispensed onto the bread 300 through the grated base portion 108 by the help of the plunger mechanism 106. Configuration of the plunger mechanism 106 will be described in conjunction with FIGS. 3A and 3B.

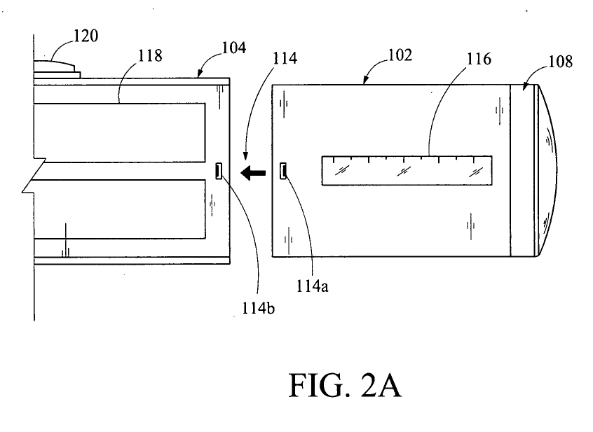

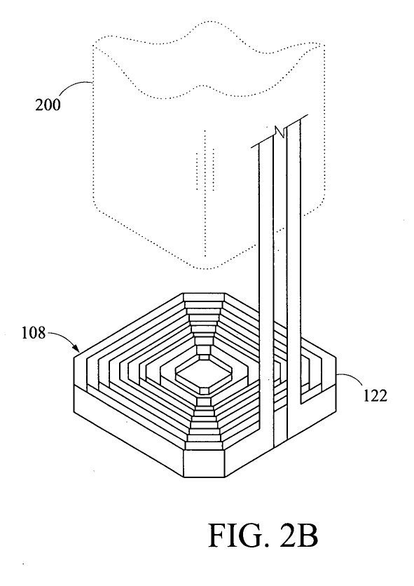

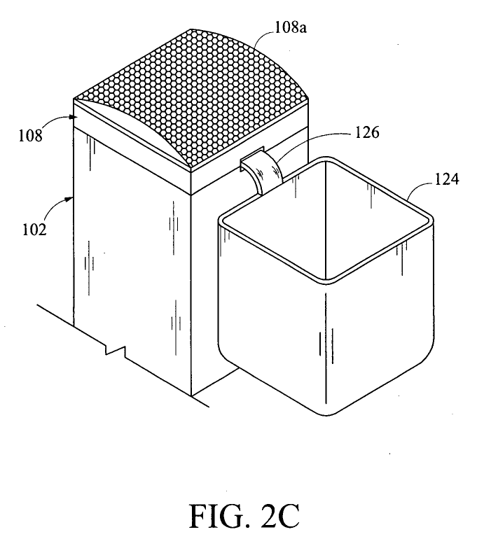

Referring now to FIGS. 2A, 2B and 2C, various components of the apparatus 100 are illustrated, in accordance with an embodiment of the present disclosure. Specifically, FIG. 2A illustrates a side view of the elongated member 102 and the powering cabinet 104. FIG. 2B illustrates a configuration of the grated base portion 108. FIG. 2C illustrates an arrangement to cover the grated base portion 108. Herein FIGS. 2A, 2B and 2C will be described in conjunction with FIG. 1.

As shown in FIG. 2A, the elongated member 102 and the powering cabinet 104 are adapted to be detachably coupled with each other via a detachable attachment 114. In one embodiment, the detachable attachment 114 includes a male lock portion 114a configured on the elongated member 102, and a female lock portion 114b configured on the powering cabinet 104. The male lock portion 114a is capable of being inserted in the female lock portion 114b for detachably coupling the elongated member 102 and the powering cabinet 104 with each other. Without departing from the scope of the present disclosure, any other type of detachable attachments may be utilized to detachably couple the elongated member 102 and the powering cabinet 104 with each other. The detachable attachment 114 facilitates an individual to detach the elongated member 102 from the powering cabinet 104 for cleaning the cavity potion 112 of the elongated member 102. Specifically, when the butter 200 is finished from the cavity portion 112 of the elongated member 102, the elongated member 102 may be detached from the powering cabinet 104 for cleaning the cavity portion 112, and refilling of butter, such as the butter 200 therein.

Further, the elongated member 102 includes a transparent window portion 116 on which measurement markings are configured. The transparent window portion 116 enables the individual to see status of the butter 200 left in the cavity portion 112 of the elongated member 102. Further, the measurement markings configured on the transparent window portion 116 enable the individual to select a desired amount of butter 200 to be dispensed from the grated base portion 108.

Furthermore as shown in FIG. 2A, the powering cabinet 104 includes a power source for supplying power to heat the grated base portion 108. In one embodiment, the power source may be a pair of batteries 118 disposed within the powering cabinet 104. The pair of batteries 118 is capable of supplying suitable electrical power supply, such as 9 volts of electrical power supply, to heat the grated base portion 108. The powering cabinet 104, separately or in combination with the elongated member 102, may be coupled to a rechargeable unit (not shown) of a refrigerator for recharging of the pair of batteries 118. In another embodiment, the powering cabinet 104 may include an electrical circuitry (not shown). The electrical circuitry may be coupled with a main power line (not shown) of home for supplying power to heat the grated base portion 108. Moreover, the powering cabinet 104 includes a switch 120. The switch 120 is configured to activate the power source, either the pair of batteries 118 or the electrical circuitry, to regulate power supply to the grated base portion 108.

Referring to FIG. 2B, the grated base portion 108 is illustrated. The grated base portion 108 is configured to include a blade type coiled heating element 122. The blade type coiled heating element 122 may extend from the grated base portion 108 to an end portion of the elongated member 102 to be electrically coupled with the powering cabinet 104. The pair of batteries 118 of the powering cabinet 104 is capable of supplying power to heat the blade type coiled heating element 122, thereby heating the grated base portion 108. More particularly, the switch 120 activates the pair of batteries 118 to supply power to heat the grated base portion 108. Further, the switch 120 may deactivate the power source to cut power supply, thereby enabling the grated base portion 108 to come to room temperature. The grated base portion 108 may be covered when the apparatus 100 is not in use. FIG. 2C illustrates an arrangement to cover the grated base portion 108, and will be described herein.

As shown in FIG. 2C, the apparatus 100 includes a covering member 124. The covering member 124 is hingebly coupled to the elongated member 102 via a flap member 126. The covering member 124 is capable of covering the grated base portion 108, when the apparatus 100 is not utilized. Further, when the apparatus 100 is required to be utilized, the covering member 124 may be removed from the grated base portion 108 of the elongated member 102, and the plunger mechanism 106 may be actuated to push the butter 200 towards the grated base portion 108 to dispense the butter 200 through the plurality of opening 108a onto the bread 300. The plunger mechanism 106 will be described herein with respect to FIGS. 3A and 3B.

Referring to FIGS. 3A and 3B, wherein FIG. 3A illustrates a sectional view of the apparatus 100 along XX′ of FIG. 1, and FIG. 3B illustrates an enlarged view of an encircled portion of the apparatus 100 of FIG. 3A, in accordance with an embodiment of the present disclosure. As shown in FIG. 3A, the plunger mechanism 106 includes a plunger 128, a pressure plate 130 and an actuating arrangement 132. The plunger 128 is pivotally coupled to the elongated member 102 via a pivot pin 136. More particularly, a bottom end portion 128a of the plunger 128 is pivotally coupled with the elongated member 102 via the pivot pin 136, and a top end portion 128b of the plunger 128 is free. The plunger 128 from the top end portion 128b is capable of being moved laterally inward and outward from the elongated member 102. Further, the pressure plate 130 is disposed within the cavity portion 112 of the elongated member 102. The pressure plate 130 is capable of reciprocately sliding within the cavity portion 112 of the elongated member 102 by the plunger 128. More particularly, the actuating arrangement 132 is operatively coupled to the plunger 128, and is capable of being actuated by the plunger 128 to reciprocately slide the pressure plate 130 within the cavity portion 112 of the elongated member 102.

The actuating arrangement 132 includes a biasing member 134, an advancing assembly 138, and a retracting lever 140. The biasing member 134 is a spring in a coiled state disposed within the cavity portion 112 with proximity to the pressure plate 130. The biasing member 134 is in proximity with a top surface of the pressure plate 130 for enabling the pressure plate 130 to reciprocately slide within the cavity portion 112. The advancing assembly 138 is operatively coupled to the elongated member 102 for advancing the biasing member 134 that slides the pressure plate 130 in a first direction “A” within the cavity portion 112.

The advancing assembly 138 includes a pressure band advance track 138a and a pressure band advance gripper jaw 138b. The pressure band advance track 138a is disposed on an inner surface 142 of the protruding member 110. Further, the pressure band advance gripper jaw 138b is pivotally coupled with the plunger 128 by pivot pins 144 and a connecting rod 146 in a manner such that the biasing member 134 passes from a space (not shown) configured between the pressure band advance track 138a and the pressure band advance gripper jaw 138b. For sliding the pressure plate 130 in the first direction “A” within the cavity portion 112, the plunger 128 is depressed. The plunger 128 when depressed enables the pressure band advance track 138a and the pressure band advance gripper jaw 138b to push the biasing member 134 against the pressure plate 130. The pressure band advance gripper jaw 138b is a one way pressure band advance gripper jaw that facilitates the biasing member 134 to move against the pressure plate 130. By depressing the plunger 128 in a successive manner, the pressure plate 130 may be moved further in the first direction “A,” thereby enabling the pressure plate 130 to push the butter 200 towards the grated base portion 108 to dispense the butter 200 therethrough onto the bread 300.

Further, the retracting lever 140 is operatively coupled to the elongated member 102 and is engaged with the biasing member 134. The retracting lever 140 is capable of retracting the biasing member 134 for enabling the pressure plate 130 to slide in a second direction “B” opposite to the first direction “A” within the cavity portion 112. More particularly, the retracting lever 140 is coupled to the elongated member 102 via a pin 148 in a manner such that a first portion 140a of the retracting lever 140 passes from a through hole (not shown) formed on the protruding member 110 and extends within the cavity portion 112 to engage with the biasing member 134. The biasing member 134 is engaged with the first portion 140a of the retracting lever 140 via a one-way band lock member 150 disposed on the first portion 140a of the retracting lever 140. Further, a second portion 140b of the retracting lever 140 is kept free for enabling the individual to depress the retracting lever 140 for enabling the one-way band lock member 150 to release the biasing member 134 to retain an original state of the biasing member 134, thereby enabling the pressure plate 130 to move in the second direction “B”.

In utility, the apparatus 100 may store the butter 200 in the cavity portion 112, and may be kept in a refrigerator to avoid spoilage and degradation of the taste of the butter 200. When required, the apparatus 100 may be retrieved from the refrigerator for dispending the butter 200 onto the bread 300. Particularly, as described above, the switch 120 is depressed for enabling the pair of batteries 118 disposed in the powering cabinet 104 to heat the grated base portion 108. Further, the plunger 128 may be depressed to enable the pressure band advance track 138a and the pressure band advance gripper jaw 138b to push the biasing member 134 against the pressure plate 130 for sliding the pressure plate 130 in the first direction “A.” The pressure plate 130 upon sliding towards the grated base portion 108 also pushes the butter 200 towards the grated base portion 108 to dispense the butter 200 onto the bread 300 through the grated base portion 108, which is heated by the powering cabinet 104.

The present disclosure provides an apparatus, such as the apparatus 100, for storing and dispensing a spreadable food item onto a substrate, which offers the following advantages. The apparatus may be used with variety of spreadable food items, such as butter, cream, cheese, jam, cake frosting, and any other spreadable or formable products. The apparatus precludes various tasks, such as slicing the spreadable food item using a knife, waiting for the temperature of the spreadable food item to come to the room temperature, and the like, to be performed while preparing the spreadable food item for consumption. The apparatus facilitates an individual to have the desired amount of spreadable food item in a time effective manner and without frustration. Further, the apparatus provides storage to the spreadable food item. The apparatus along with the spreadable food item stored therein may be stored in a refrigerator, thereby precluding spoilage and degradation of the taste of the spreadable food item.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the claims of the present disclosure.

What is claimed is:

1. An apparatus for storing and dispensing a spreadable food item onto a substrate, the apparatus comprising:
an elongated member, the elongated member comprising
a grated base portion, and
a projecting portion extending vertically from the grated base portion for configuring a cavity portion, the cavity portion capable of storing the spreadable food item;
a powering cabinet detachably coupled to the elongated member for supplying power to heat the grated base portion; and
a plunger mechanism operatively coupled to the elongated member, wherein the plunger mechanism is capable of being actuated to push the spreadable food item stored within the cavity portion towards the grated base portion, thereby dispensing the spreadable food item through the grated base portion heated by the powering cabinet onto the substrate.

2. The apparatus of claim 1, wherein the plunger mechanism comprises:
a plunger pivotally coupled to the elongated member;
a pressure plate disposed within the cavity portion of the elongated member, the pressure plate capable of reciprocately sliding within the cavity portion; and
an actuating arrangement operatively coupled to the plunger, the actuating arrangement capable of being actuated by the plunger to reciprocately slide the pressure plate within the cavity portion.

3. The apparatus of claim 2, wherein the actuating arrangement comprises:
a biasing member disposed within the cavity portion with proximity to the pressure plate for enabling the pressure plate to reciprocately slide within the cavity portion;
an advancing assembly operatively coupled to the elongated member, the advancing assembly capable of advancing the biasing member to slide the pressure plate in a first direction within the cavity portion; and
a retracting lever operatively coupled to the elongated member and engaged with the biasing member, the retracting lever capable of retracting the biasing member for enabling the pressure plate to slide in a second direction opposite to the first direction within the cavity portion.

4. The apparatus of claim 1, wherein the powering cabinet comprises a power source for supplying power to heat the grated base portion.

5. The apparatus of claim 1, wherein the powering cabinet comprises an electrical circuitry, the electrical circuitry adapted to be coupled with a main power line of home for supplying power to heat the grated base portion.

6. The apparatus of claim 1 further comprising a covering member hingebly coupled to the elongated member for covering the grated base portion.

7. The apparatus of claim 1, wherein the elongated member comprises a transparent window portion, the transparent window portion comprising measurement markings thereon.
